(19) United States
(12) Patent Application Publication
(10) Pub. No.: US 2015/0069943 A1
(43) Pub. Date: Mar. 12, 2015

(54) MOTOR DRIVING CONTROL APPARATUS, MOTOR DRIVING CONTROL METHOD, AND MOTOR SYSTEM USING THE SAME

(71) Applicant: SAMSUNG ELECTRO-MECHANICS CO., LTD., Suwon (KR)

(72) Inventor: Joo Yul KO, Suwon (KR)

(73) Assignee: SAMSUNG ELECTRO-MECHANICS CO., LTD., Suwon (KR)

(21) Appl. No.: 14/086,954

(22) Filed: Nov. 21, 2013

(30) Foreign Application Priority Data
Sep. 9, 2013 (KR) 10-2013-0108101

(51) Int. Cl. H02P 6/18

(52) U.S. Cl. CPC H02P 6/182
USPC 318/400.35

(57) ABSTRACT

There are provided a motor driving control apparatus, a motor driving control method and a motor system using the same. The motor driving control apparatus includes: a back-electromotive-force detecting unit detecting back electromotive force generated by a motor apparatus; a floating correcting unit, if zero-crossing has not occurred in a current floating area, correcting the floating area by predicting a time at which a zero-crossing occurs; and a control unit determining a zero-crossing time of the back electromotive force based on an output from the floating correcting unit and controlling driving of the motor apparatus using the determined zero-crossing time.

### CROSS-REFERENCE TO RELATED APPLICATION

This application claims the benefit of Korean Patent Application No. 10-2013-0108101 filed on Sep. 9, 2013, with the Korean Intellectual Property Office, the disclosure of which is incorporated herein by reference.

### BACKGROUND

The present disclosure relates to a motor driving control apparatus, a motor driving control method, and a motor system using the same.

As motor technology evolves, motors having various sizes have been used in a wide range of technical fields.

Typically, a motor is driven by rotating a rotor using a permanent magnet and a coil having polarities changed according to a current applied thereto. An early type of motor is a brush-type motor having a coil on a rotor, which may have a problem, for example, in that the brush may be worn out or sparks may occur due to the driving of the motor.

For this reason, various types of brushless motor are commonly being used nowadays. A brushless motor is a direct current motor that eliminates a mechanical contact portion such as a brush and a commutator and instead uses electromagnetic commutating devices. Typically, a brushless motor may include coils each corresponding to the respective phases, a stator that generates magnetic force by a phase voltage in each of the coils, and a rotor that is formed of a permanent magnet and rotates by magnetic force produced by the stator.

In order to control the driving of such a brushless motor, it is necessary to locate the position of the rotor so as to provide the phase voltage alternately. Previously, in order to locate the position of the rotor, back electromotive force has been used to estimate the position of the rotor.

However, at the time of initially driving a motor or when an error occurs in a floating area in which back electromotive force is detected, a zero-crossing time may not be detected from the back electromotive force so that it may be difficult to drive the motor accurately.

The following Patent Documents relate to the motor technology, but do not teach any technical feature to overcome the above-mentioned problems.

### RELATED ART DOCUMENTS

### (Patent Document 1) Korean Patent Laid-Open Publication No. 1997-0055430

### (Patent Document 2) Japanese Patent Laid-Open Publication No. 2011-0024401

### SUMMARY

An aspect of the present disclosure may provide a motor driving control apparatus and a motor driving control method capable of accurately driving a motor, when no zero-crossing time is detected from a current floating area of back electromotive force, by resetting the current floating area correctly using the detected back electromotive force, and a motor system using the same.

According to an aspect of the present disclosure, a motor driving control apparatus may include: a back-electromotive-force detecting unit detecting the back electromotive force generated by the motor apparatus; a floating correcting unit, if zero-crossing has not occurred in a current floating area, correcting the floating area by predicting a time at which zero-crossing will occur; and a control unit determining a zero-crossing time of the back electromotive force based on an output from the floating correcting unit and controlling driving of the motor apparatus using the determined zero-crossing time.

The floating correcting unit, if no zero-crossing point has been detected in the current floating area, may estimate a gradient of the back electromotive force of the current floating area to predict the time at which zero-crossing will occur.

The floating correcting unit may include: a floating area determiner determining the current floating area of the back electromotive force; a zero-crossing detector determining if a zero-crossing point has been detected in the current floating area; and a gradient estimator estimating the gradient of the back electromotive force in the current floating area.

The floating correcting unit may further include a floating area corrector estimating a first point at which a zero-crossing point will be detected using the estimated gradient of the back electromotive force if no zero-crossing point has been detected in the current floating area, and correcting the floating area so that the floating area includes the estimated first point.

The gradient estimator may determine a maximum value and a minimum value of the back electromotive force in the current floating area and estimate the gradient of the back electromotive force using the maximum value and the minimum value.

The gradient estimator may estimate the gradient of the back electromotive force using a first back electromotive force at a starting point of the current floating area and a second back electromotive force at an end point of the current floating area.

According to another aspect of the present disclosure, a motor system may include: a motor apparatus rotating according to a driving signal; and a motor driving control apparatus correcting a floating area of back electromotive force of the motor apparatus to determine a zero-crossing time of the back electromotive force and using the determined zero-crossing time to output the driving signal.

The motor driving control apparatus may include: a back-electromotive-force detecting unit detecting the back electromotive force generated by the motor apparatus; a floating correcting unit, if zero-crossing has not occurred in a current floating area, correcting the floating area by predicting a time at which zero-crossing will occur; and a control unit determining a zero-crossing time of the back electromotive force based on an output from the floating correcting unit and controlling driving of the motor apparatus using the determined zero-crossing time.

The floating correcting unit, if no zero-crossing point has been detected in the current floating area, may estimate a gradient of the back electromotive force of the current floating area to predict the time at which zero-crossing will occur.

The floating correcting unit may include: a floating area determiner determining the current floating area of the back electromotive force; a zero-crossing detector determining if a zero-crossing point has been detected in the current floating area; and a gradient estimator estimating the gradient of the back electromotive force in the current floating area.

The floating correcting unit may further include a floating area corrector estimating a first point at which a zero-crossing point will be detected using the estimated gradient of the back electromotive force if no zero-crossing point has been detected in the current floating area, and correcting the floating area so that the floating area includes the estimated first point.

The gradient estimator may determine a maximum value and a minimum value of the back electromotive force in the current floating area and estimate the gradient of the back electromotive force using the maximum value and the minimum value.

The gradient estimator may estimate the gradient of the back electromotive force using a first back electromotive force at a starting point of the current floating area and a second back electromotive force at an end point of the current floating area.

According to another aspect of the present disclosure, a motor driving control method performed in a motor driving control apparatus for controlling driving of a motor apparatus may include: applying a start signal to the motor apparatus to detect back electromotive force from the motor apparatus; determining if zero-crossing has occurred in a current floating area of the detected back electromotive force; and correcting the floating area by estimating a gradient of the back electromotive force, if zero-crossing has not occurred.

The determining may include: determining a current floating area of the back electromotive force; and determining if a zero-crossing point has been detected in the current floating area.

The correcting may include: estimating a gradient of the back electromotive force in the current floating area; and estimating a zero-crossing point using the estimated gradient and correcting the floating area so that the floating area includes the estimated zero-crossing point.

The estimating of the gradient of the back electromotive force may include: determining a maximum value and a minimum value of the back electromotive force in the current floating area; and estimating the gradient of the back electromotive force using a linear function including the maximum value and the minimum value.

The estimating of the gradient of the back electromotive force may include: determining a first back electromotive force at a starting point of the floating area and a second back electromotive force at an end point of the floating area; and estimating the gradient of the back electromotive force using a linear function including the first back electromotive force and the second back electromotive force.

### BRIEF DESCRIPTION OF DRAWINGS

The above and other aspects, features and other advantages of the present disclosure will be more clearly understood from the following detailed description taken in conjunction with the accompanying drawings, in which:

FIG. 1 is a block diagram illustrating a motor system according to an exemplary embodiment of the present disclosure;

FIG. 2 is a graph illustrating a floating area before floating correction;

FIG. 3 is a block diagram of an example of the floating correcting unit of FIG. 1;

FIGS. 4 and 5 are graphs illustrating an example of floating correction;

FIGS. 6 and 7 are graphs illustrating another example of the floating correction; and

FIG. 8 is a flowchart illustrating a motor driving control method according to an exemplary embodiment of the present disclosure.

### DETAILED DESCRIPTION

Hereinafter, embodiments of the present invention will be described in detail with reference to the accompanying drawings. The invention may, however, be embodied in many different forms and should not be construed as being limited to the embodiments set forth herein. Rather, these embodiments are provided so that this disclosure will be thorough and complete, and will fully convey the scope of the invention to those skilled in the art. Throughout the drawings, the same or like reference numerals will be used to designate the same or like elements.

In the following description, a motor apparatus 200 refers to a motor, and a motor system refers to a system that includes the motor apparatus 200 and a motor driving control apparatus 100 for driving the motor apparatus 200.

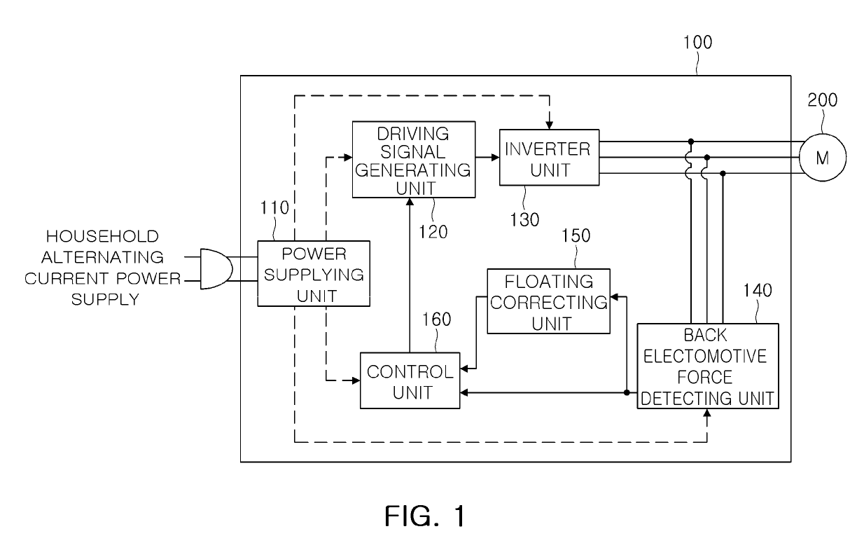

FIG. 1 is a block diagram illustrating a motor system according to an exemplary embodiment of the present disclosure.

A motor driving control apparatus 100 may control the rotation of the motor apparatus 200 by providing a predetermined signal, e.g., a driving signal to the motor apparatus 200.

In an exemplary embodiment, the motor driving control apparatus 100 may correct a floating area of back electromotive force of the motor apparatus 200 to determine a zero-crossing time of the back electromotive force and may output a driving signal using the determined zero-crossing time.

The motor apparatus 200 may rotate according to the driving signal. For example, each of the coils in the motor apparatus 200 may generate a magnetic field according to the driving current (driving signal) provided from the inverter unit 130. The rotor included in the motor apparatus 200 may be rotated by the magnetic fields generated in the coils as described above.

Specifically, the motor driving control apparatus 100 may include a power supply unit 110, a driving signal generating unit 120, an inverter unit 130, a back-electromotive-force detecting unit 140, a floating correcting unit 150, and a control unit 160.

The power supply unit 110 may supply power to each of the components in the motor driving control apparatus 100. For example, the power supplying unit 110 may convert a household alternating current (AC) voltage into a direct current (DC) voltage to supply the converted DC voltage. In the example shown, a dashed line denotes a predetermined power supplied from the power supply unit 110.

The driving signal generating unit 120 may control the inverter unit 130 so that it generates a driving signal.

The inverter unit 130 may provide a driving signal to the motor apparatus 200. For example, the inverter unit 130 may convert a direct current voltage into a multi-phase (e.g., three-phase) voltage according to a predetermined signal provided from the driving signals generating unit 120. The inverter unit 130 may apply multiple phase voltages to the coils in the motor apparatus 200, each of which corresponds to the respective phases, so that rotor of the motor apparatus 200 may be operated.

The back-electromotive force detecting unit 140 may detect back-electromotive force generated by the motor apparatus 200.

More specifically, while the motor apparatus 200 is being rotated, back electromotive force is generated in the coils provided in the stator by the rotation of the rotor. That is, back-electromotive force may be generated in a one of the plurality of coils to which a phase voltage is not applied, and the back-electromotive force detecting unit 140 may detect the back-electromotive force thus generated in the coil of the motor apparatus 200.

Here, a phase from which no back electromotive force is detected is a phase to which no driving signal is applied currently. For example, in a three-phase motor having phase a, phase b, and phase c, in the case that a positive (+) signal is applied to phase a and a negative (−) signal is applied to phase c, back electromotive force may be detected from phase b. This is because an electromotive (back electromotive) is generated in phase b to which no signal is applied as the rotor rotates by the magnetic field in phases a and b.

In order to detect such back electromotive force, a floating area is set. The floating area may be defined by a predetermined time unit.

The floating correcting unit 150 may determine if a zero-crossing occurs in a current floating area. If it is determined that zero-crossing has not occurred in the current floating area, the floating correcting unit 150 may predict a time at which zero-crossing will occur so as to correct the floating area.

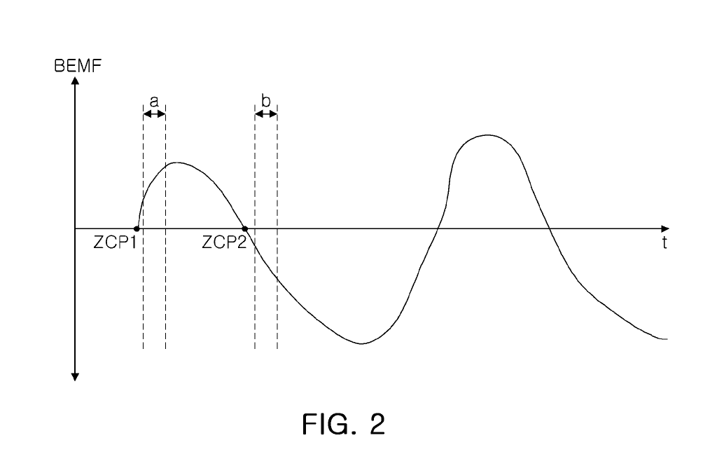

The floating correcting unit 150 will be described below in more detail with reference to FIGS. 2 to 7.

The control unit 160 may determine the phase commutation point of the motor apparatus 200 and may control the driving signal generating unit 120 so that it generates the driving signal using the determined phase commutation point.

In an exemplary embodiment, the control unit 160 may determine a zero-crossing time of back electromotive force based on the output from the floating correcting unit 150 and may control the driving of the motor apparatus 200 using the determined zero-crossing time. For example, the control unit 160 may control the motor apparatus 200 such that a phase changed is made at a zero-crossing time of back electromotive force.

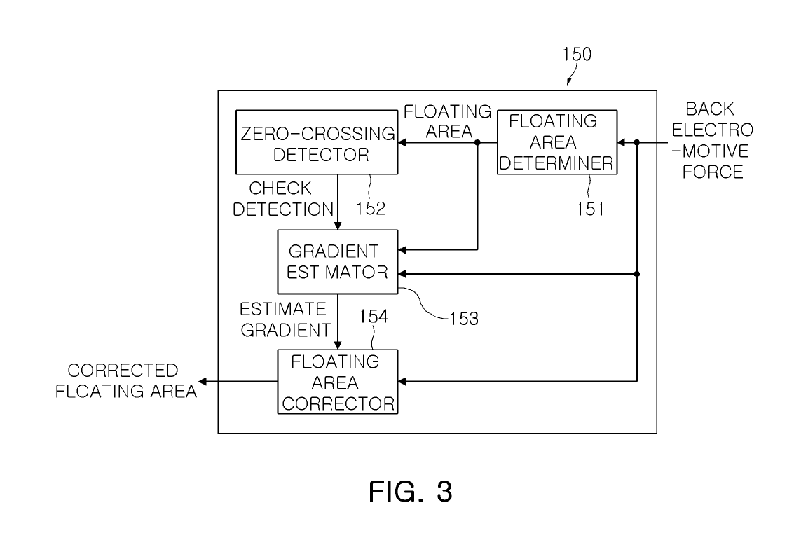

FIG. 2 is a graph illustrating a floating area before floating correction, and FIG. 3 is a block diagram of the floating correcting unit of FIG. 1 according to an exemplary embodiment.

First of all, the graph in FIG. 2 represents back electromotive force. In the example shown, the current floating points are labeled as area “a” and area “b.”

As can be seen from the example shown, the current floating points, area “a” and area “b” are displaced from zero-crossing points ZCP1 and ZCP2, respectively.

This often happens when a stationary motor is initially driven (i.e., at the start of a motor). Further, floating points may be displaced as shown, when an error occurs in a phase change time.

When the floating points are displaced as shown, zero-crossing points may not be correctly detected. Accordingly, even when a phase change is necessary, it is erroneously determined as a normal state, so that a phase change may not be made.

According to an exemplary embodiment of the present disclosure, such errors in the floating points may be corrected by using the floating correcting unit 150.

Referring to FIG. 3, the floating correcting unit 150 may include a floating area determiner 151, a zero-crossing detector 152, and a gradient estimator 153. In some exemplary embodiments, the floating correcting unit 150 may further include a floating area corrector 154.

The floating area determiner 151 may determine a current floating area of back-electromotive force. For example, the floating area determiner 151 may check a driving signal so as to determine a predetermined time interval corresponding to the current floating area.

The zero-crossing detector 152 may determine if a zero-crossing point has been detected in the current floating area.

The gradient estimator 153 may estimate a gradient of back electromotive force in the current floating area.

The floating area corrector 154, if no zero-crossing point has been detected in the current floating area, may use the estimated gradient of the back electromotive force to estimate a first point at which a zero-crossing point will be detected. The floating area corrector 154 may correct a floating area so that it includes the estimated first point.

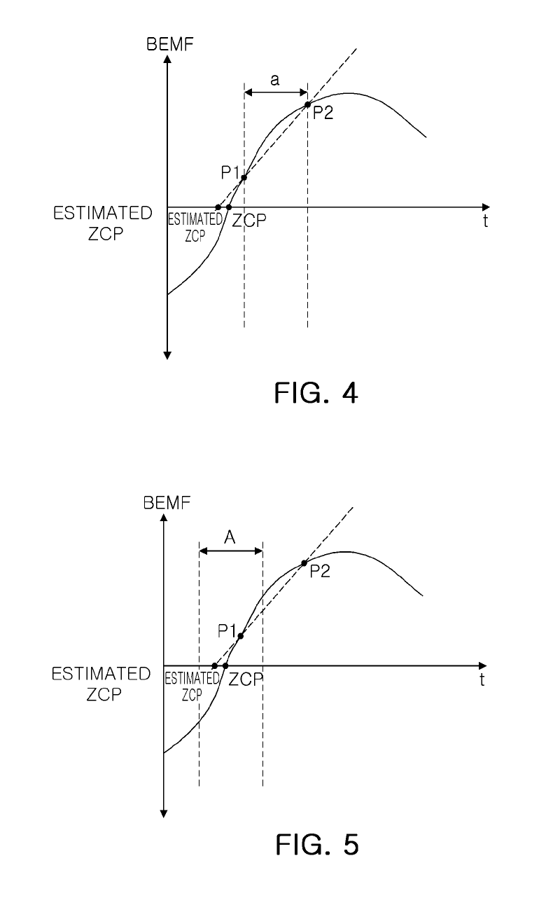

Such gradient estimation and floating area correction will be described below in more detail with reference to FIGS. 4 to 7.

FIGS. 4 and 5 are graphs illustrating an example of floating correction. FIG. 4 is a graph before the floating correction is performed while FIG. 5 is a graph after the floating correction is performed.

Referring to FIGS. 3 to 5, the floating area determiner 151 may determine and output the current floating area a. The current floating area a does not include a zero-crossing point ZCP and thus the zero-crossing detector 152 may notify the gradient estimator 153 that no zero-crossing point has been detected in the current floating area a.

The gradient estimator 153 may receive that back electromotive force, the current floating area a and whether a zero-crossing point is in the current floating area a. The gradient estimator 153, upon receiving a signal indicating that no zero-crossing point is in the current floating area a, may estimate a gradient based on the back electromotive force and the current floating area a.

The gradient estimator 153 may use a first back electromotive force P1 at the starting point of the floating area a and a second back electromotive force P2 at the endpoint of the floating area a to estimate the gradient of the back electromotive force.

The floating area corrector 154 may correct the current floating area a by a floating area A based on the gradient of the back electromotive force estimated by the gradient estimator 153.

In an exemplary embodiment, the floating area corrector 154 may calculate an estimated zero-crossing point (an estimated ZCP) using the estimated gradient of the back electromotive force and may set the floating area A such that it includes the estimated zero-crossing point (the estimated ZCP).

In an exemplary embodiment, the floating area corrector 154 may set the floating area A such that it includes the estimated zero-crossing point (the estimated ZCP) at the center thereof.

That is, in the examples illustrated in FIGS. 4 and 5, as described above, a linear function is established that includes the first back electromotive force P1 at the starting point of the floating area a and the second back electromotive force P2 at the end point of the floating area a, by which the gradient of the back electromotive force is estimated.

The estimated zero-crossing point (the estimated ZCP) may be calculated from the estimated gradient of the back electromotive force. The estimated zero-crossing point (the estimated ZCP) may be slightly different from an actual zero-crossing point (ZCP), however.

However, such a difference is so small as to be ignored compared to the range of the corrected floating area A. Even with such a difference, an actual zero-crossing point ZCP may lie within the corrected floating area A.

Accordingly, by correcting the current floating area a by the floating area A, a zero-crossing point is highly likely to lie within the floating area A, thereby increasing the accuracy of motor control.

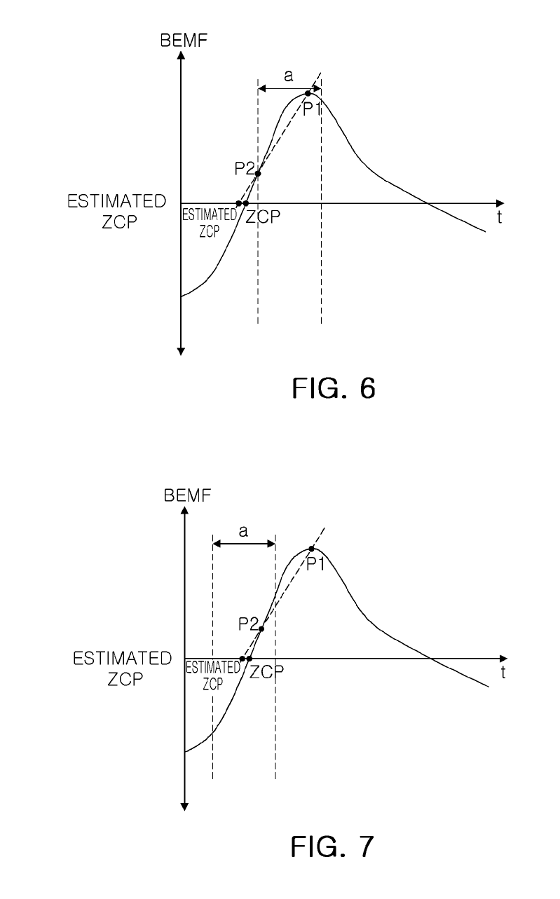

FIGS. 6 and 7 are graphs illustrating another example of the floating correction. FIGS. 6 and 7 illustrate an example of estimating a gradient of back electromotive force by using maximum and minimum values of the back electromotive force in a current floating area.

Similarly to the example in FIGS. 4 and 5, the floating area determiner 151 may determine and output the current floating area a. The current floating area a does not include a zero-crossing point ZCP and thus the zero-crossing detector 152 may notify the gradient estimator 153 that no zero-crossing point has been detected in the current floating area a.

The gradient estimator 153, upon receiving a signal indicating that no zero-crossing point is in the current floating area a, may estimate a gradient based on the back electromotive force and the current floating area a.

Specifically, the gradient estimator 153 may determine the maximum value P1 and the minimum value P2 of the back electromotive force in the current floating area a and may use them to estimate the gradient of the back electromotive force.

In an exemplary embodiment, the gradient estimator 153 may estimate the gradient of the back electromotive force such that it corresponds to a linear function including the maximum value P1 and the minimum value P2 of the back electromotive force in the current floating area a.

As described above, the floating area corrector 154 may calculate an estimated zero-crossing point (an estimated ZCP) based on the estimated gradient and may correct the current floating area a by the floating area A so as to include it.

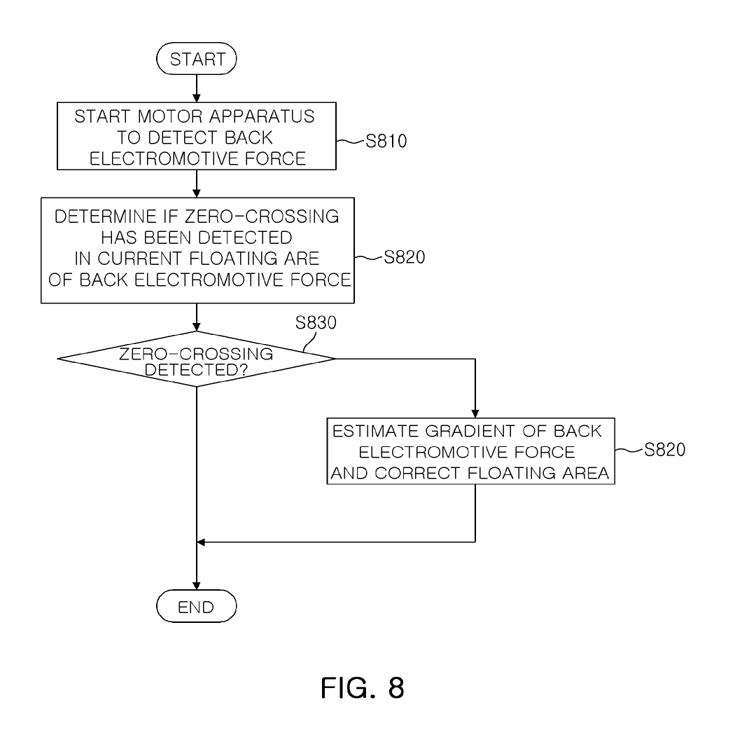

FIG. 8 is a flow chart for illustrating a method for motor driving control according to an exemplary embodiment of the present disclosure.

Hereinafter, a method for a motor driving control according to the exemplary embodiment of the present disclosure will be described with reference to FIG. 8. Since the method for motor driving control according to the exemplary embodiment is performed in the motor driving control apparatus 100 described above with reference to FIGS. 1 to 7, overlapped descriptions on parts that are the same as or correspond to the above-mentioned parts will be omitted.

Referring to FIGS. 1 to 8, the motor driving control apparatus 100 may apply a predetermined start signal to the motor apparatus 200 and may detect back electromotive force from the motor apparatus 200 (S810).

The motor driving control apparatus 100 may determine if a zero crossing occurs in the current floating area of the detected electromotive force (S820).

If zero-crossing has not occurred (NO in S830), the motor driving control apparatus 100 may estimate the gradient of the back electromotive force to correct the floating area (S840).

In operation S820, the motor driving control apparatus 100 may determine the current floating area of the back electromotive force and may determine if a zero-crossing point has been detected in the current floating area.

In operation S840, the motor driving control apparatus 100 may estimate the gradient of the back electromotive force in the current floating area. Then, the motor driving control apparatus 100 may estimate a zero-crossing point using the estimated gradient and may correct the floating area so that it includes the estimated zero-crossing point.

In estimating the gradient of the back electromotive force, the motor driving control apparatus 100 may determine maximum and minimum values of the back electromotive force in the current floating area. Then, the motor driving control apparatus 100 may use a linear function including the maximum and minimum values so as to estimate the gradient of the back electromotive force.

Alternatively, in estimating the gradient of the back electromotive force, the motor driving control apparatus 100 may determine a first back electromotive force at the starting point of the floating area and a second back electromotive force at the endpoint of the floating area. Then, the motor driving control apparatus 100 may use a linear function including the first and second back electromotive forces so as to estimate the gradient of the back electromotive force.

As set forth above, according to exemplary embodiments of the present disclosure, when no zero-crossing is detected from a current floating area of back electromotive force, a motor can be accurately driven by resetting the current floating area correctly using the detected back electromotive force.

While exemplary embodiments have been shown and described above, it will be apparent to those skilled in the art that modifications and variations could be made without departing from the spirit and scope of the present disclosure as defined by the appended claims.

What is claimed is:

1. A motor driving control apparatus, comprising:
a back-electromotive-force detecting unit detecting back electromotive force generated by a motor apparatus;
a floating correcting unit, if zero-crossing has not occurred in a current floating area, correcting the floating area by predicting a time at which zero-crossing will occur; and
a control unit determining a zero-crossing time of the back electromotive force based on an output from the floating correcting unit and controlling driving of the motor apparatus using the determined zero-crossing time.

2. The motor driving control apparatus of claim 1, wherein the floating correcting unit, if no zero-crossing point has been detected in the current floating area, estimates a gradient of the back electromotive force of the current floating area to predict the time at which zero-crossing will occur.

3. The motor driving control apparatus of claim 1, wherein the floating correcting unit includes: a floating area determiner determining the current floating area of the back electromotive force; a zero-crossing detector determining if a zero-crossing point has been detected in the current floating area; and a gradient estimator estimating the gradient of the back electromotive force in the current floating area.

4. The motor driving control apparatus of claim 3, wherein the floating correcting unit further includes a floating area corrector estimating a first point at which a zero-crossing point will be detected using the estimated gradient of the back electromotive force if no zero-crossing point has been detected in the current floating area, and correcting the floating area so that the floating area includes the estimated first point.

5. The motor driving control apparatus of claim 3, wherein the gradient estimator determines a maximum value and a minimum value of the back electromotive force in the current floating area and estimates the gradient of the back electromotive force using the maximum value and the minimum value.

6. The motor driving control apparatus of claim 3, wherein the gradient estimator estimates the gradient of the back electromotive force using a first back electromotive force at a starting point of the current floating area and a second back electromotive force at an end point of the current floating area.

7. A motor system, comprising:
a motor apparatus rotating according to a driving signal; and
a motor driving control apparatus correcting a floating area of back electromotive force of the motor apparatus to determine a zero-crossing time of the back electromotive force and using the determined zero-crossing time to output the driving signal.

8. The motor system of claim 7, wherein the motor driving control apparatus includes:
a back-electromotive-force detecting unit detecting the back electromotive force generated by the motor apparatus;
a floating correcting unit, if zero-crossing has not occurred in a current floating area, correcting the floating area by predicting a time at which zero-crossing will occur; and
a control unit determining a zero-crossing time of the back electromotive force based on an output from the floating correcting unit and controlling driving of the motor apparatus using the determined zero-crossing time.

9. The motor system of claim 8, wherein the floating correcting unit, if no zero-crossing point has been detected in the current floating area, estimates a gradient of the back electromotive force of the current floating area to predict the time at which zero-crossing will occur.

10. The motor system of claim 8, wherein the floating correcting unit includes:
a floating area determiner determining the current floating area of the back electromotive force;
a zero-crossing detector determining if a zero-crossing point has been detected in the current floating area; and
a gradient estimator estimating the gradient of the back electromotive force in the current floating area.

11. The motor system of claim 10, wherein the floating correcting unit further includes a floating area corrector estimating a first point at which a zero-crossing point will be detected using the estimated gradient of the back electromotive force if no zero-crossing point has been detected in the current floating area, and correcting the floating area so that the floating area includes the estimated first point.

12. The motor system of claim 10, wherein the gradient estimator determines a maximum value and a minimum value of the back electromotive force in the current floating area and estimates the gradient of the back electromotive force using the maximum value and the minimum value.

13. The motor system of claim 10, wherein the gradient estimator estimates the gradient of the back electromotive force using a first back electromotive force at a starting point of the current floating area and a second back electromotive force at an end point of the current floating area.

14. A motor driving control method performed in a motor driving control apparatus for controlling driving of a motor apparatus, the motor driving control method comprising:
applying a start signal to the motor apparatus to detect back electromotive force from the motor apparatus;
determining if zero-crossing has occurred in a current floating area of the detected back electromotive force; and
correcting the floating area by estimating a gradient of the back electromotive force, if zero-crossing has not occurred.

15. The motor driving control method of claim 14, wherein the determining includes:
determining a current floating area of the back electromotive force; and
determining if a zero-crossing point has been detected in the current floating area.

16. The motor driving control method of claim 14, wherein the correcting includes:
estimating a gradient of the back electromotive force in the current floating area; and
estimating a zero-crossing point using the estimated gradient and correcting the floating area so that the floating area includes the estimated zero-crossing point.

17. The motor driving control method of claim 16, wherein the estimating of the gradient of the back electromotive force includes:
determining a maximum value and a minimum value of the back electromotive in the current floating area; and
estimating the gradient of the back electromotive force using a linear function including the maximum value and the minimum value.

18. The motor driving control method of claim 16, wherein the estimating of the gradient of the back electromotive force includes:
determining a first back electromotive force at a starting point of the floating area and a second back electromotive force at an end point of the floating area; and
estimating the gradient of the back electromotive force using a linear function including the first back electromotive force and the second back electromotive force.
